(19) United States
(12) Patent Application Publication
(10) Pub. No.: US 2008/0242535 A1
(43) Pub. Date: Oct. 2, 2008

(54) Honeycomb Structural Body and Method of Fabricating the Same

(75) Inventors: James Jenq Liu, Mason, OH (US); Jerry G. Weinstein, Malta, NY (US)

Correspondence Address: GEO2 TECHNOLOGIES, 12-R CABOT ROAD, WOBURN, MA, 01801, US

(73) Assignee: GEO2 TECHNOLOGIES, INC., Woburn, MA (US)

(21) Appl. No.: 11/695,586

(22) Filed: Apr. 2, 2007

(51) Int. Cl. B32B 3/12; B01J 21/06; B01J 21/18; C01B 31/36; B01D 39/16

(52) U.S. Cl. 502/232; 264/29.6; 428/117; 502/413; 502/232; 55/528

(57) ABSTRACT

A fibrous silicon carbide substrate is disclosed that is formed from a reaction between carbon fibers and silicon additives, to provide in-situ silicon carbide fibers. The fibrous structure is formed from a paper-making process of carbon or organic fibers that form a plurality of lamination members. The lamination members, each having a plurality of through holes, that when aligned in a lamination direction, form a honeycomb array of channels. The lamination members can be adapted into a wall-flow configuration for use in filtration of the exhaust of internal combustion engines.

### BACKGROUND OF THE INVENTION

The present invention relates generally to silicon carbide substrates useful for filtration and/or high temperature chemical reaction processing, such as a catalytic host. The invention more particularly relates to a substantially fiber-based silicon carbide substrate and methods for producing the same.

Ceramic honeycomb substrates are commonly used in industrial and automotive applications where inherent material stability and structural integrity are needed at elevated operating temperatures. Ceramic honeycomb substrates provide high specific surface area for effective filtration and support for efficient catalytic reactions. For example, in automotive applications, ceramic substrates are used in catalytic converters to host catalytic oxidation and reduction of exhaust gases, and to filter particulate emissions.

Ceramic honeycomb substrates are typically used in a Diesel Particulate Filter (DPF) to trap diesel exhaust particles, such as soot. When used in a DPF, the ceramic honeycomb is fabricated in a wall-flow configuration by selectively plugging alternate channels to form inlet channels and outlet channels. Every other extruded channel is plugged on the inlet side, and the remaining channels are plugged on the outlet side, thereby forcing the exhaust flow into the inlet channels, through the porous ceramic material that forms the walls of the channels, and out of the filter through the outlet channels. During operation, the soot particles accumulate on the surface of the inlet channel walls, which will ultimately increase the system backpressure. The diesel engine control system monitors backpressure and other indicators, and periodically initiates a regeneration of the filter through a controlled burn-off of the accumulated soot. If the diesel engine controls fail to maintain control of the periodic filter regeneration, too much soot may accumulate and an uncontrolled regeneration may occur, which can result in extremely high temperature gradients within the honeycomb filter, leading to potential failure of substrates.

DPF substrates have been fabricated from an extruded powder-based ceramic material, such as cordierite or silicon carbide. Cordierite, 2MgO.2Al₂O₃.5SiO₂, is a commonly used ceramic material for monolithic catalyst support applications, such as vehicular catalytic converters. Cordierite is typically formed by extruding a mixture of particles of kaolin, talc, calcined kaolin, calcined talc, alumina, aluminum hydroxide, and silica, followed by a high temperature firing process to form cordierite in-situ. The choice of raw materials and processing determines the porosity created in the side walls. The material exhibits a relatively low melting point compared to the operating temperature of a DPF during regeneration. Cordierite is a relatively inexpensive to fabricate, and has a low thermal coefficient of expansion, but the material cannot maintain structural integrity when operating temperatures exceed 1300° Celsius. That, combined with occasional cracking observed when large thermal gradients are created during regenerations, can lead to catastrophic failures.

Silicon carbide, as a material, is desirable for high temperature filtration applications since the material exhibits significantly high thermal conductivity as well as high volumetric heat capacity, that effectively reduce the magnitude of thermal gradients during regeneration in a DPF ceramic honeycomb substrate. Silicon carbide is also chemically stable and inert, and mechanically strong when bonded. Current commercial silicon carbide substrates are typically formed by extruding a mixture of silicon carbide particles and an organic binder, followed by a sintering process that burns off the binder and sinters the silicon carbide particles into a porous structure. In another example, silicon metal powder is used to bond SiC particles together. The drawback of extruding SiC powders is that the highly abrasive particles rapidly wear extrusion dies and equipment used in expensive high pressure extruders. Additionally, the sintering process requires temperatures sometimes in excess of 2000 degrees Celsius for long periods (8-12 hours or more) in an inert environment such as argon.

Porous ceramic honeycomb substrates can also be made from ceramic fibers, as disclosed in commonly owned U.S. Pat. No. 6,946,013, and commonly owned U.S. patent applications Ser. No. 10/833,298 (published as US2005/0042151) and Ser. No. 11/322,544 (published as US2006/0120937), all incorporated herein by reference. The advantage of a fibrous ceramic structure is the improved porosity, permeability, and specific surface area that results from the open network of pores created by the intertangled ceramic fibers, the mechanical integrity of the bonded fibrous structure, and the inherent low cost of extruding and curing the ceramic fiber substrates. The commercial application of this technology, however, is limited by the availability of low cost ceramic fibers. Low cost silicon carbide fibers are not readily or commercially available.

Porous ceramic honeycomb substrates of ceramic fibers have also been fabricated in a honeycomb form using laminations of ceramic fiber-based paper elements, as disclosed in U.S. patent application Ser. No. 10/518,373 (published as US2006/0075731), incorporated herein by reference. This method of fabrication does not have the benefit of low-cost extrusion, but the fabrication method is adaptable to the use of expensive silicon carbide fibers to provide a high temperature and robust porous substrate.

Accordingly, there is a need for fibrous ceramic honeycomb structure that possesses the thermal and mechanical properties of a silicon carbide honeycomb substrate, with the performance and fabrication cost advantage of alternative ceramic materials and fabrication processes.

### BRIEF SUMMARY OF THE INVENTION

The present invention provides an improved silicon carbide substrate that is formed from an in-situ formation of silicon carbide from carbon or carbonaceous fibers. A honeycomb structural body that has a plurality of through holes that form a partition wall between each channel that is formed from the lamination of members that are formed from in-situ silicon carbide. The lamination members each have through holes, that when laminated, are superimposed on one another to form the honeycomb channels. The honeycomb structure is adapted into a wall-flow configuration by sealing one of the ends of the through holes. The honeycomb structural body of the present invention can be adapted for use a filter.

Catalyst coatings can be applied to the in-situ silicon carbide fibers in order to provide catalytic reactions for oxidation and/or reduction of harmful constituents of exhaust gases, such as in a diesel particulate filter.

In an embodiment of the invention, carbon fiber is mixed into a slurry with silicon additives to form a carbon-fiber paper. The carbon-fiber paper is then subjected to a silicon carbide formation process by heating in an inert environment to a temperature that, for example, exceeds the melting point of silicon metal. In this forming step, the carbon fiber and the silicon additives react to form silicon carbide (i.e., in-situ silicon carbide).

In an alternate embodiment of the invention, carbon fiber is used to form a carbon fiber paper lamination member. The lamination member is heated in an inert environment with the addition of silicon additives, for example, in a melt-infiltration process. The carbon fiber and the silicon additives react to form in-situ silicon carbide fiber lamination members, that can then be assembled into the structural body. In further embodiments, the carbon fiber paper lamination elements can be assembled into the structural body, with the addition of silicon additives. In a forming process, the carbon fiber and the silicon additives react to form in-situ silicon carbide.

It is an object of the present invention to provide a laminated porous structural body that comprises in-situ silicon carbide fibers. In this way, the fabrication steps to form a silicon carbide porous substrate are not subjected to either the high cost of silicon carbide fibers, or the expense of processing the same. The high bonding temperatures and the difficulty of handling the extremely abrasive silicon carbide raw materials is thereby avoided.

### BRIEF DESCRIPTION OF THE SEVERAL VIEWS OF THE DRAWING

The drawings constitute a part of this specification and include exemplary embodiments of the invention, which may be embodied in various forms.

FIG. 1 is a perspective view that schematically shows a specific example of a honeycomb structural body according to the present invention.

FIG. 2 is a cross-sectional view taken along line A-A of the honeycomb structural body shown in FIG. 1.

FIG. 3 is a perspective view that schematically shows a specific example of a filter assembly using the honeycomb structural body according to the present invention.

FIG. 4 is a cross-sectional representation of the honeycomb structural body of the present invention configured in a wall-flow configuration for a filtration application.

FIG. 5 is a perspective view of the lamination members of the present invention.

FIG. 6 is a flowchart representing an embodiment of the method of fabricating the porous honeycomb structural body according to the present invention.

FIG. 7 is a flowchart representing an alternate embodiment of the method of fabricating the porous honeycomb structural body according to the present invention.

### DETAILED DESCRIPTION OF THE INVENTION

Detailed descriptions of examples of the invention are provided herein. It is to be understood, however, that the present invention may be exemplified in various forms. Therefore, the specific details disclosed herein are not to be interpreted as limiting, but rather as a representative basis for teaching one skilled in the art how to employ the present invention in virtually any detailed system, structure or manner.

The present invention relates to a honeycomb structural body that exhibits an effective trapping efficiency, with sufficient mechanical durability and robustness for use as an exhaust filtration element. The chemical properties of the honeycomb structural body is extremely robust even at elevated temperatures that may be experienced during regeneration cycles to burn out accumulated soot and particulates. The honeycomb structural body of the present invention provides these benefits with a low inherent backpressure, even when sufficient levels of soot and particulates are accumulated in the filter. Low backpressure is an important characteristic of an exhaust filter as the performance of an internal combustion engine can be severely degraded with increased exhaust backpressure.

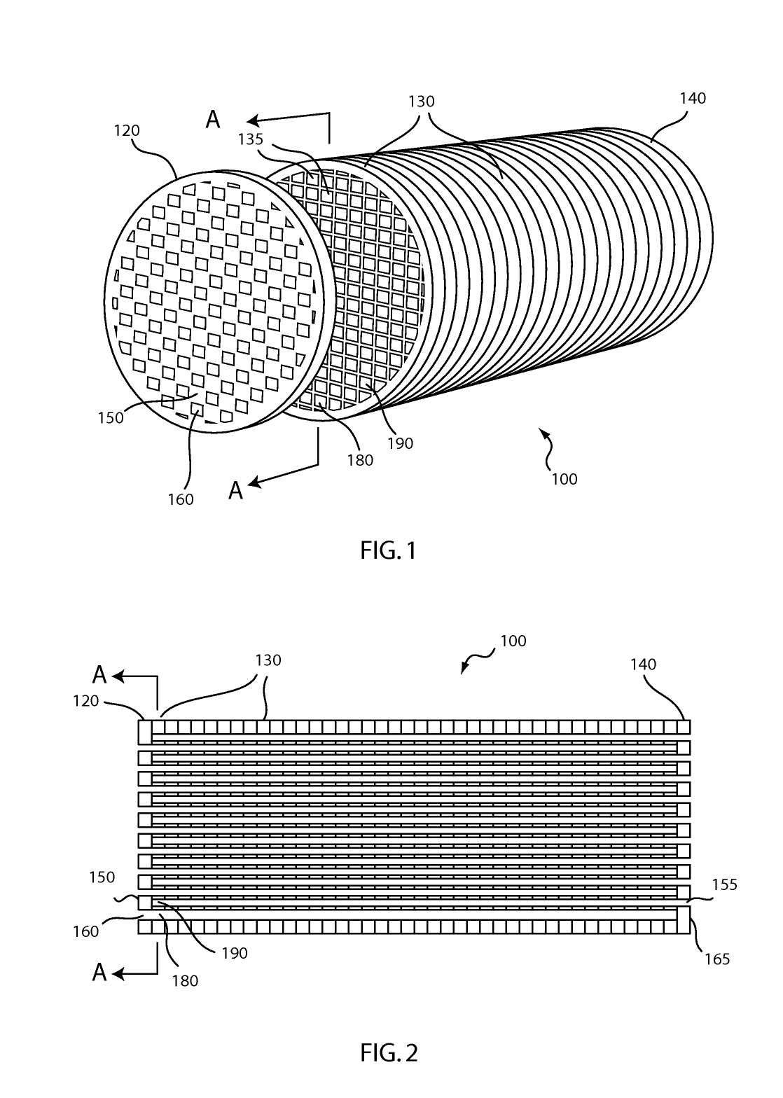

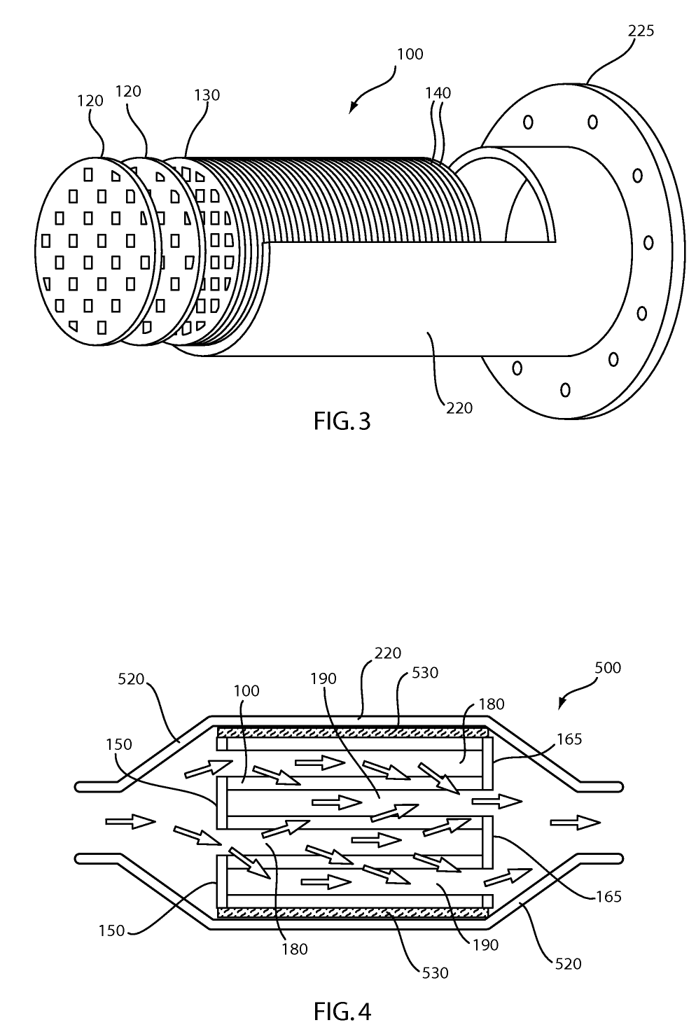

The honeycomb structural body of the present invention, is generally shown in FIG. 1. The structural body 100 is a columnar structural body having a plurality of channels in a substantially parallel relative arrangement. The structural body 100 is composed of a lamination of porous in-situ silicon carbide lamination members 130, each having an array of through holes that are in substantial relative alignment when stacked in a lamination. FIG. 2 depicts a cross-sectional view of the structural body 100 through a plane A-A as shown. As shown in FIG. 1 and FIG. 2, an inlet sealing lamination member 120 is provided to alternately block every other channel so that an inlet channel 160 is aligned with inlet channel 180, and outlet channel 190 is blocked by the inlet channel block 150 in the inlet sealing member 120. Similarly, an outlet sealing member 140 is configured with an outlet channel 155 that is aligned with the outlet channel 190, with the outlet channel block 165 that blocks the inlet channel 180. Accordingly, flow of a fluid enters the inlet channel 180 to be forced through the porous lamination members 130 to exit the structural body 100 through the outlet channel 190.

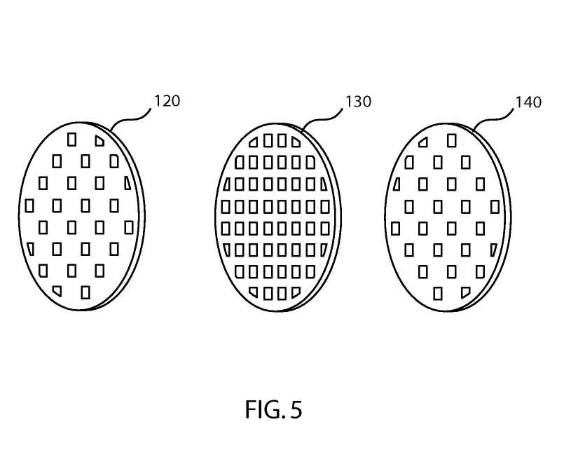

As shown in FIG. 1, the honeycomb structural body 100 of the present invention is a laminated member comprising porous in-situ silicon carbide lamination members 130, each having a thickness of 0.1 to 20 mm. The lamination members 130 are laminated so that the channel openings 135 are substantially aligned to the respective channel openings in the adjacent lamination members 130 in the length direction. As shown in FIG. 2, the channel openings 180 and the channel openings 190 in the porous lamination members 130, when laminated in substantial alignment, cooperate to form inlet channels Referring to FIG. 3, the honeycomb structural body 100 is shown as a filter assembly 200 in a partially cut-away perspective view. Each of the in-situ silicon carbide lamination members 130 are a porous fibrous structure having discontinuities at their respective faces so that when laminated on one another, gas can flow through the walls that form the channels in the structural body 100. The structural body 100 is placed within a filter housing 220 having a flange 225 mounted at each end (only one end is shown with the flange 225 for clarity). As discussed with reference to FIG. 1 and FIG. 2, one or more inlet sealing members 120 are placed on the inlet end of the structural body 100 so that inlet channels 180 are exposed while blocking outlet channels 190. Conversely, one or more outlet sealing members 140 are placed on the outlet end of the structural body 100 to expose the outlet channels 190 while blocking the inlet channels 180. In this manner, the filter assembly is adapted to a wall-flow configuration, as shown in FIG. 4.

Referring to FIG. 4, a representation of a wall-flow filter assembly 500 is shown to filter the exhaust from an internal combustion engine. The exhaust gas from the internal combustion engine (not shown) is routed into the filter assembly 500 through the exhaust inlet 520 into the honeycomb structural body 100. The inlet channel block 150 directs the flow of exhaust into the inlet channel 180, where it is forced to flow through the walls of the structural body 100, and/or through the discontinuities between the faces of laminated members 130, due to the outlet channel block 165. Once the gas is in the outlet channel 190, it is free to exit the structural body 100 into the exhaust outlet 520. Often, an intumescent mat 530 will be used to wrap around the structural body 100 so that the exhaust gas is prevented to slip by the interface between the structural body and the filter housing 220.

Referring now the FIG. 5, the inlet sealing member 120, the in-situ silicon carbide lamination member 130, and the outlet sealing member 140 is shown. The lamination member 120 (and the inlet sealing member 120 and the outlet sealing member 140, to which the following discussion implicitly includes), is composed of a fibrous silicon carbide material that is formed in-situ. For the purposes of this description, the term “in-situ silicon carbide” infers that a silicon carbide object, such as the lamination member 120, and/or the structural body 100, is fabricated into its general form and converted in-situ to silicon carbide. As discussed below, the present invention provides a porous structure through a fibrous silicon carbide material without the inherent difficulties of processing the extremely abrasive, and very expensive silicon carbide material. Instead, the fabrication processes involve handling and processing carbon or organic fibers that are converted into silicon carbide.

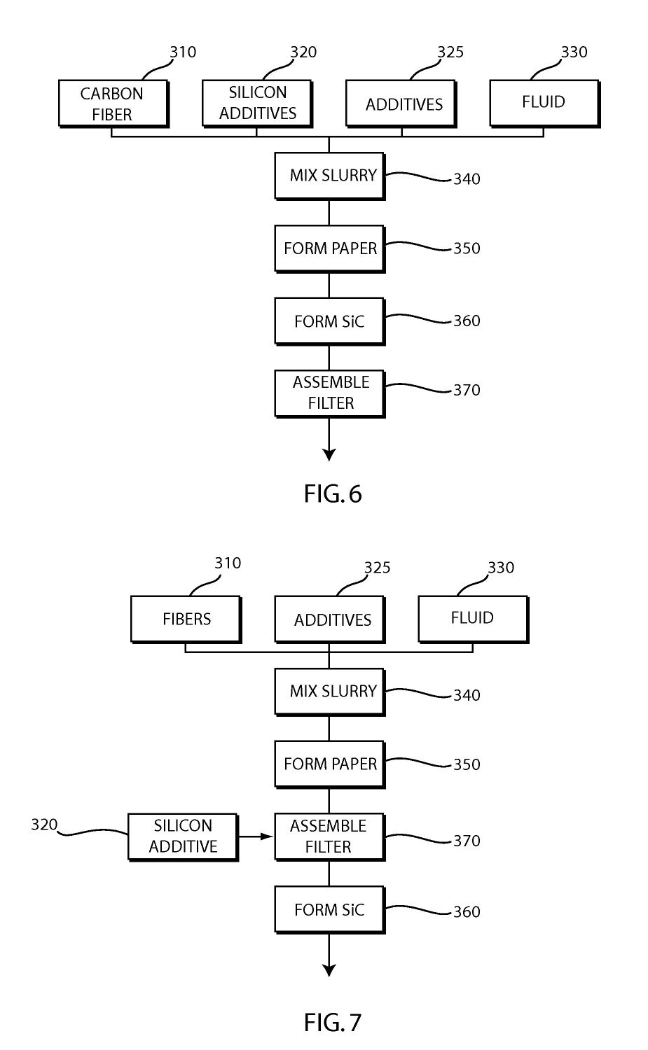

In a first embodiment, the in-situ silicon carbide lamination member 130 can be fabricated by the method shown in FIG. 6. Carbon fiber 310 (carbonaceous type fiber) is mixed with silicon additives 320 and a fluid 330 into a slurry at step 340. The carbon fiber 310 can be polyacrilnitrizile (PAN) fibers or petroleum pitch fibers, of the type commonly used in carbon-fiber reinforced composites, or a variety of carbonized organic fibers such as polymeric fibers, rayon, cotton, wood or paper fibers, or polymeric resin filaments. The carbon fiber diameter can be 1 to 30 microns in diameter, though for intended applications such as exhaust filtration, a preferred range of fiber diameter is 3 to 10 microns can be used. The fiber diameter and length is not materially changed in the subsequent formation of silicon carbide, and thus, the selection of the carbon fiber characteristics should generally match the desired fiber structure of the final product. PAN or Pitch fibers, and carbonized synthetic fibers, such as rayon or resin, will have more consistent fiber diameters, since the fiber diameter can be controlled when they are made. Naturally occurring fibers, such as carbonized cotton, wood, or paper fibers will have an increased variation and less-controlled fiber diameter. The carbon fibers 310 are typically chopped or milled to any of a variety of lengths for convenience in handling, and to ensure even distribution of fibers in the mix. It is expected that the shearing forces imparted on the fibers during the subsequent mixing step 340 will shorten at least a portion of the fibers. A preferable lower limit length of the fibers is 0.1 mm and a preferable upper limit length of the fiber is 100 mm.

The silicon additives 320 can be in the form of silicon metal particles or silicon oxide (silica) particles, such as colloidal silica. The fluid 330 can be water, or a solvent solution. Additives 325 can be included in the mixture, such as organic and inorganic binders, that may facilitate the subsequent paper-making process, and to provide for structural enhancement of the lamination member 130 without detracting from the overall porosity of the member. Organic binders can include, without limitation, acrylic latex, methylcellulose, carboxymethylcellulose, hydroxyethylcellulose, polyethylene glycol, phenol resin, epoxy resin, polyvinyl alcohol and styrene-butadiene rubber. At step 340, the a slurry is formed that is mixed to form an evenly distributed mixture of the fibers 310, silicon additives, 320 and the fluid 330.

In order to form silicon carbide fibers from the carbon fibers 310 and the silicon additives 320, the silicon content of the silicon particles must be provided in approximately a stoichiometric ratio to form silicon carbide, and evenly distributed throughout the lamination member 130. Silicon-based particles can be material provided in the form of silicon metal particles, fumed silicon, silicon microspheres, silica-based aerogels, polysilicon, silane or silazane polymers, or from other silicon-based compounds, such as amorphous, fumed, or colloidal silicon dioxide (silica). Colloidal silica can also be used for the silicon-based component of the additives 120. Colloidal silica is a stable dispersion of discrete particles of amorphous silica (SiO₂), sometimes referred to as a silica sol. Colloidal silica is commercially available with particle sizes between 5 nm and 5 μm dispersed in an aqueous or solvent solution, typically around 30-50% solid concentration. The small particle size of colloidal silica, when mixed with the carbon fibers 310, permits a uniform distribution of the silicon-based component with the carbon fiber, so that the silica can effectively coat the surface of the individual carbon fibers. The stoichiometric ratio of silicon carbide will be attained with a ratio of three parts carbon to one part Silica (3:1), though the ratio of materials added to the mixture can include excess carbon or excess silica, for example, the mixture can be in the range of about 5:1 and 2:1 carbon:silica.

Alternatively, the silicon-based constituent of the additives 120 can be silicon metal particles with a sufficiently fine particle size to be fully and evenly dispersed during processing. Purity of the silicon is not essential for the silicon carbide formation reaction to occur, but metallic contaminants may alter the application and effectiveness of any subsequent catalyst layer. Preferably, the particle size of the silicon additives 320 is as small as commercially available. Silicon powder in the 1 to 4 μm size or silicon nanoparticles are desirable, though lower cost materials are typically associated with particles in the 30 to 60 μm size. The larger particles are sufficiently small enough to be effectively distributed for the formation of silicon carbide. The stoichiometric molar ratio of silicon carbide will be attained with a ratio of about 1:1 carbon:silicon, though the ratio can be extreme, resulting in either excess carbon or excess silicon. Excess silicon is advantageous to make up for silicon or silicon monoxide that may be lost during the process (due to volatility at high temperatures), and/or to provide available silicon for metal bonds. Additionally, excess silicon residing on the formed silicon carbide fibers can act as a protective coating, which can be advantageous when used with catalysts that include materials such as potassium that can otherwise chemically degrade the silicon carbide material.

The slurry is then subjected to a paper-making process at step 350, to form a carbon fiber paper with an even distribution of silicon particles. More specifically, a perforated mesh in which holes having a predetermined shape can be formed with mutually predetermined intervals, and the resulting matter dried in a range from 100° C. to 200° C. so that a honeycomb-shaped lamination member 130, which has through holes and a predetermined thickness is obtained.

Moreover, in the case where a lamination member is an inlet sealing member 120 or an outlet sealing member 140, that forms the end face of the structural member 100 to adapt the same in a wall-flow configuration, a mesh having holes with a predetermined shape that form a staggered pattern is formed at a predetermined thickness.

Next, at step 360, the lamination member is subjected to an elevated thermal environment to form silicon carbide from the carbon fibers 310 and the silicon additives 320. At this step, the dried paper, i.e., the carbon fiber and the silicon-additives are heated in an environment sufficient to form silicon carbide from the carbon fibers. Organic binders are pyrolized and decomposed during this forming step 360, while leaving the fibrous structure in generally the same relative position within the paper.

The chemical reaction during this final phase of the forming step 360 is generally described to be:

C+Si→SiC

though when the silicon-based component is silica, the reaction can be described to be:

3C+SiO₂→SiC+2CO₂

It is to be appreciated that in this reaction, intermediate transitionary compounds may form before stable SiC is formed.

The above reaction will take place when the structure is heated to a temperature of about 1400 to 1800 degrees Celsius, for approximately 2 to 4 hours or more, in an inert environment. When silicon metal is included as the silicon-additives 320, the silicon particles will melt at above 1414 degrees Celsius, which will then wet to, and coat the carbon fibers to convert into silicon carbide. This wetting is optimized in vacuum atmosphere conditions where silicon metal will spontaneously wet elemental carbon, including the fiber itself or wetting of a residual carbon layer remaining from the burn out of a binder additive.

When silica is used as the silicon additive 320, there is a solid state (solid-solid) reaction that goes on that is diffusion dependent:

3C+SiO₂→SiC+2CO₂

There may be a secondary reaction is that the SiO2 first vaporizes to SiO, and this then reacts with the carbon to form silicon carbide, thus resulting in the following gas-solid reaction:

2C+2SiO→2SiC+O₂

An inert environment is necessary to ensure the absence of oxygen to prevent the oxidation of the carbon into carbon dioxide. The resulting structure is generally silicon-carbide fibers in an intertangled and overlapping relationship, forming an open network of pores. It can be appreciated that the resulting microstructure formed within the substrate is largely based on the intertangled fiber architecture originally composed of the carbon or organic fibers, and the formation of silicon carbide during the forming step 360 does not substantially change the relative position of the fibers.

The forming step 360 can be carried out in a conventional batch or continuous furnace or kiln. The inert environment can be maintained by purging the furnace or kiln with nitrogen, argon, helium, neon, forming gas and mixtures thereof, or any inert gas or gaseous mixture. It is important to have a little to none partial pressure of oxygen, so as to prevent adverse reactions from occurring that can lead to oxidation and volatilization of the reactive species. Alternatively, the forming step 360 can be performed in a vacuum environment, which would typically require a vacuum of 200.0 torr or less. The forming step 360 can be performed by a sequential progression through multiple batch or continuous kilns, or the sequence of heating steps, i.e., drying, binder burnout, and reaction formation, can be performed in a single facility that can maintain the sequential temperature environments in a manual or automatic fashion.

At step 370, the in-situ silicon carbide lamination members 130, and the inlet sealing member 120 and outlet sealing member 140, are laminated into the honeycomb structural body 100 to form a filter assembly 200. In this assembly step, catalytic materials can be applied through the application of a washcoat and catalyst materials, as further described below.

The in-situ silicon carbon fibers are aligned generally in parallel with the main face of the lamination member 130. When the structural body 100 is formed at step 370, a substantial portion of the fibers are aligned along the face perpendicular to the forming direction of the through holes in comparison with those aligned along the horizontal face with respect to the forming direction of the through holes. Therefore, since the honeycomb structural body 100 permits exhaust gases to pass through the wall portion more easily, it is possible to minimize the impact of the filter assembly 200 on system backpressure, and to allow particulates to penetrate deep into the lamination members 130 (i.e., a depth filter).

A second embodiment of the present invention is depicted in reference to FIG. 7. In this embodiment, carbon fiber 310 (carbonaceous type fiber) is mixed with a fluid 330 into a slurry at step 340. The carbon fiber 310 can be polyacrilnitrizile (PAN) fibers or petroleum pitch fibers, of the type commonly used in carbon-fiber reinforced composites, or a variety of carbonized organic fibers such as polymeric fibers, rayon, cotton, wood or paper fibers, or polymeric resin filaments. The carbon fiber diameter can be 1 to 30 microns in diameter, though for intended applications such as exhaust filtration, a preferred range of fiber diameter is 3 to 10 microns can be used. The fiber diameter and length is not materially changed in the subsequent formation of silicon carbide, and thus, the selection of the carbon fiber characteristics should generally match the desired fiber structure of the final product. PAN or Pitch fibers, and carbonized synthetic fibers, such as rayon or resin, will have more consistent fiber diameters, since the fiber diameter can be controlled when they are made. Naturally occurring fibers, such as carbonized cotton, wood, or paper fibers will have an increased variation and less-controlled fiber diameter. The carbon fibers 310 are typically chopped or milled to any of a variety of lengths for convenience in handling, and to ensure even distribution of fibers in the mix. It is expected that the shearing forces imparted on the fibers during the subsequent mixing step 340 will shorten at least a portion of the fibers. A preferable lower limit length of the fibers is 0.1 mm and a preferable upper limit length of the fiber is 100 mm.

The fluid 330 can be water, or a solvent solution. Additives 325 can be included in the mixture, such as organic and inorganic binders, that may facilitate the subsequent paper-making process, and to provide for structural enhancement of the lamination member 130 without detracting from the overall porosity of the member. Organic binders can include, without limitation, acrylic latex, methylcellulose, carboxymethylcellulose, hydroxyethylcellulose, polyethylene glycol, phenol resin, epoxy resin, polyvinyl alcohol and styrene-butadiene rubber. At step 340, the a slurry is formed that is mixed to form an evenly distributed mixture of the fibers 310, additives, 325 and the fluid 330.

The slurry is then subjected to a paper-making process at step 350, to form a carbon fiber paper. More specifically, a perforated mesh in which holes having a predetermined shape can be formed with mutually predetermined intervals, and the resulting matter dried in a range from 100° C. to 200° C. so that a honeycomb-shaped lamination member 130, which has through holes and a predetermined thickness is obtained.

Moreover, in the case where a lamination member is an inlet sealing member 120 or an outlet sealing member 140, that forms the end face of the structural member 100 to adapt the same in a wall-flow configuration, a mesh having holes with a predetermined shape that form a staggered pattern is formed at a predetermined thickness.

Next, at step 370, the lamination members 130 and the inlet sealing member 120 and the outlet sealing member 140, all in a carbon fiber paper form, are assembled into the honeycomb structural body 100, with the addition of a silicon additive 320. The silicon additive 320 can be in the form of a colloidal suspension of silicon or silica particles applied by immersion, or the lamination members 130 can be laminated with a thin wafer of silicon interleaved between each lamination member.

Next, at step 360, the lamination member is subjected to an elevated thermal environment to form silicon carbide from the carbon fibers 310 and the silicon additives 320. At this step, the dried paper, i.e., the carbon fiber and the silicon-additives are heated in an environment sufficient to form silicon carbide from the carbon fibers. Organic binders are pyrolized and decomposed during this forming step 360, while leaving the fibrous structure in generally the same relative position within the paper.

The chemical reaction during this final phase of the forming step 360 is generally described to be:

C+Si→SiC

though when the silicon-based component is silica, the reaction can be described to be:

3C+SiO₂→SiC+2CO₂

It is to be appreciated that in this reaction, intermediate transitionary compounds may form before stable SiC is formed.

The above reaction will take place when the structure is heated to a temperature of about 1400 to 1800 degrees Celsius, for approximately 2 to 4 hours or more, in an inert environment. When silicon metal is included as the silicon-additives 320, the silicon particles will melt at above 1414 degrees Celsius, which will then wet to, and coat the carbon fibers to convert into silicon carbide. This wetting is optimized in vacuum atmosphere conditions where silicon metal will spontaneously wet elemental carbon, including the fiber itself or wetting of a residual carbon layer remaining from the burn out of a binder additive.

When silica is used as the silicon additive 320, there is a solid state (solid-solid) reaction that goes on that is diffusion dependent:

3C+SiO₂→SiC+2CO₂

There may be a secondary reaction is that the SiO2 first vaporizes to SiO, and this then reacts with the carbon to form silicon carbide, thus resulting in the following gas-solid reaction:

2C+2SiO→2SiC+O₂

An inert environment is necessary to ensure the absence of oxygen to prevent the oxidation of the carbon into carbon dioxide. The resulting structure is generally silicon-carbide fibers in an intertangled and overlapping relationship, forming an open network of pores. It can be appreciated that the resulting microstructure formed within the substrate is largely based on the intertangled fiber architecture originally composed of the carbon or organic fibers, and the formation of silicon carbide during the forming step 360 does not substantially change the relative position of the fibers.

The forming step 360 can be carried out in a conventional batch or continuous furnace or kiln. The inert environment can be maintained by purging the furnace or kiln with nitrogen, argon, helium, neon, forming gas and mixtures thereof, or any inert gas or gaseous mixture. It is important to have a little to none partial pressure of oxygen, so as to prevent adverse reactions from occurring that can lead to oxidation and volatilization of the reactive species. Alternatively, the forming step 360 can be performed in a vacuum environment, which would typically require a vacuum of 200.0 torr or less. The forming step 360 can be performed by a sequential progression through multiple batch or continuous kilns, or the sequence of heating steps, i.e., drying, binder burnout, and reaction formation, can be performed in a single facility that can maintain the sequential temperature environments in a manual or automatic fashion.

In a modification to the second embodiment, the silicon additive 320 can be introduced to the carbon fibers of the laminated members 130 through melt infiltration during the forming step 360. In this alternate embodiment, the carbon fibers of the lamination members are exposed to molten silicon metal, that immediately wets to, and flows throughout the carbon fiber structure, so that the reaction to form silicon carbide can occur. The molten silicon metal is typically introduced to the carbon fiber in the forming step 360 in a vacuum kiln or inert environment, though at least a single strand of carbon fiber that is immersed in a crucible of silicon metal within the kiln.

In a variation of this modification to the second embodiment, carbon-fiber lamination members can be assembled into the structural body, and the entire structural body can have the silicon additive 320 introduced in a melt infiltration forming step 360. In this way, the silicon metal that wets over the carbon fiber to react with the carbon fiber to form in-situ silicon carbide, also provides silicon bonds and silicon carbide crystallized bonds between the fibers and between the lamination members 130.

In yet further embodiments, organic fiber-based paper can be carbonized to form a carbon-fiber paper having through holes in predetermined locations to form lamination members 130, inlet sealing members 120, and outlet sealing members. The paper materials can be made from rayon, cotton, wood, polymeric resins. The paper lamination elements are carbonized to convert the organic fiber into carbon fiber by heating the organic-fiber paper lamination element. In this embodiment, the organic fibers are converted into elemental carbon through pyrolyzation of the organic material, while maintaining the fibrous structure of the paper. The carbonization step is performed, for example, by heating the paper to approximately 1,000° C. for about four to five hours in an inert environment. The inert environment is necessary for this step so that the carbon is not oxidized after it is formed, and so that the remaining additives are not oxidized. In this alternate embodiment, the carbon fiber resulting from the carbonization step may shrink as much as 70% in diameter, and thus, the thickness of the organic fiber must be initially larger than the thickness of a carbon fiber in the first two embodiments to attain a similar structure. Using the methods described above in reference to the first or second embodiments, silicon additives 320 can be added, so that in-situ silicon carbide is formed.

Once the honeycomb structural body 100 is assembled, and the in-situ silicon carbide fibers has been completed, any number of catalysts and washcoats can be disposed within the honeycomb structural body 100 to chemically alter combustion byproducts in the exhaust stream by catalysis. Such a catalyst includes but is not limited to platinum, palladium (such as palladium oxide), rhodium, derivatives thereof including oxides, and mixtures thereof. In addition, the catalysts are not restricted to noble metals, combination of noble metals, or only to oxidation catalysts. Other suitable catalysts and washcoats include chromium, nickel, rhenium, ruthenium, silver, osmium, iridium, platinum, tungsten, barium, yttrium, neodymium, lanthanum, gadolinium, praseodymium, and gold, derivatives thereof, and mixtures thereof. Other suitable catalysts include binary oxides of palladium, aluminum, tungsten, cerium, zirconium, and rare earth metals. Other suitable catalysts include vanadium and derivatives thereof, e.g., V2O5, or silver or copper vanadates, particularly when sulfur is present in the fuel or lubricant. Further still, the substrate 510 can be configured with a combination of catalysts applied to different sections or zones to provide a multi-functional catalyst. For example, the substrate 510 can be used as a particulate filter with soot-oxidizing catalysts applied to the inlet channel walls, with a NOx adsorber, or selective catalyst reduction catalyst applied to the internal fibrous structure in the channel walls. Similar configurations can be applied to provide NOx traps or 4-way catalytic converters.

The present invention has been herein described in detail with respect to certain illustrative and specific embodiments thereof, and it should not be considered limited to such, as numerous modifications are possible without departing from the spirit and scope of the appended claims.

1. A honeycomb structural body comprising: a structure in which a plurality of through holes are placed in parallel with one another in the length direction with a partition wall interposed therebetween;
wherein lamination members formed of in-situ silicon carbide fibers, are laminated in the length direction so that the through holes are superimposed on one another; and
one of the ends of each through hole is sealed.

2. The honeycomb structural body according to claim 1 wherein each of a plurality of through holes is sealed at one of the ends of the honeycomb structural body, and wherein the honeycomb structural body functions as a filter.

3. The honeycomb structural body according to claim 1 further comprising a catalyst disposed on the silicon carbide fibers.

4. The honeycomb structural body according to claim 1 wherein the in-situ silicon carbide fibers are formed from a paper comprising carbon fibers and silicon metal.

5. The honeycomb structural body according to claim 4 wherein the silicon metal is melt-infiltrated into the carbon fibers.

6. The honeycomb structural body according to claim 4 wherein the carbon fibers comprise carbonized organic fiber.

7. The honeycomb structural body according to claim 6 wherein the carbonized organic fiber is a carbonized wood-based paper.

8-16. (canceled)

17. A honeycomb structural body comprising:
lamination members comprising inorganic fibers forming a paper having a first composition, the lamination members having a plurality of through holes placed in parallel with one another to form a honeycomb structure;
the lamination members fabricated from a paper-making process using fibers having a second composition that is different than the first composition.

18. The honeycomb structural body according to claim 17 wherein the first composition is silicon carbide and the second composition is carbon.

19. The honeycomb structural body according to claim 18 wherein the paper-making process further comprises a silicon additive.

20. The honeycomb structural body according to claim 17 wherein the first composition is silicon carbide and the second composition is organic fiber.
